(19) United States
(12) Patent Application Publication
(10) Pub. No.: US 2021/0385413 A1
(43) Pub. Date: Dec. 9, 2021

(54) PRODUCT ASSEMBLY MACHINE HAVING VISION INSPECTION STATION

(71) Applicants: TE Connectivity Services GmbH, Schaffhausen (CH); Tyco Electronics (Shanghai) Co., Ltd., Shanghai (CN)

(72) Inventors: Du Wen, Reading, PA (US); Lei Zhou, Shanghai (CN); Roberto Francisco-Yi Lu, Bellevue, WA (US)

(21) Appl. No.: 16/940,571

(22) Filed: Jul. 28, 2020

(30) Foreign Application Priority Data
Jun. 3, 2020 (CN) 202010493393.X

(51) Int. Cl. H04N 7/18; B25J 9/16; B25J 15/06; B65G 47/82; G06T 7/00

(52) U.S. Cl. CPC H04N 7/18; B25J 9/1697; H04N 5/2628; B65G 47/82; G06T 7/001; B25J 15/0616

(57) ABSTRACT

A product assembly machine includes a platform supporting parts configured to be assembled to form an assembled product and moving the assembled product from an assembling station to a vision inspection station. The assembling station has a part assembly member for assembling the parts into the assembled product. The vision inspection station includes an imaging device to image the assembled product and a vision inspection controller receiving images from the imaging device and processing the images from the imaging device based on an image analysis model to determine inspection results for the assembled product. The vision inspection controller has an artificial intelligence learning module operated to update the image analysis model based on the images received from the imaging device

### CROSS REFERENCE TO RELATED APPLICATIONS

This application claims benefit to Chinese Application No. 202010493393.X, filed 3 Jun. 2020, the subject matter of which is herein incorporated by reference in its entirety.

### BACKGROUND OF THE INVENTION

The subject matter herein relates generally to product assembly machines.

Inspection systems are used for inspecting parts or products during a manufacturing process to detect defective parts or products. Conventional inspection systems use personnel to manually inspect parts. Such manual inspection systems are labor intensive and high cost. The manual inspection systems have low detection accuracy leading to poor product consistency. Additionally, manual inspection systems suffer from human error due to fatigue, such as missed defects, wrong counts, misplacing of parts, and the like. Some known inspection systems use machine vision for inspecting parts or products. The machine vision inspection system use cameras to image the parts or products. However, vision inspection may be time consuming. Hardware and software for operating the vision inspection machines is expensive.

A need remains for a vision inspection system for a product assembly machine that may be operated in a cost effective and reliable manner.

### BRIEF DESCRIPTION OF THE INVENTION

In an embodiment, a product assembly machine is provided including a platform supporting parts configured to be assembled to form an assembled product and moving the assembled product from an assembling station to a vision inspection station. The assembling station has a part assembly member for assembling the parts into the assembled product. The vision inspection station includes an imaging device to image the assembled product and a vision inspection controller receiving images from the imaging device and processing the images from the imaging device based on an image analysis model to determine inspection results for the assembled product. The vision inspection controller has an artificial intelligence learning module operated to update the image analysis model based on the images received from the imaging device.

In an embodiment, a product assembly machine is provided including a rotary platform having an upper surface, a first part feeding device feeding a first part to the rotary platform, a second part feeding device feeding a second part to the rotary platform, and an assembling station having a part assembly member for assembling the first part with the second part into an assembled product. The rotary platform is used to move at least one of the first part and the second part to the assembling station. The product assembly machine includes a vision inspection station adjacent the rotary platform. The rotary platform moves the assembled product from the assembling station to the vision inspection station. The vision inspection station includes an imaging device to image the assembled product and a vision inspection controller receiving images from the imaging device and processing the images from the imaging device based on an image analysis model to determine inspection results for the assembled product. The vision inspection controller has an artificial intelligence learning module operated to update the image analysis model based on the images received from the imaging device. The rotary platform is used to move the inspected assembled product to a product removal device to remove the inspected assembled product based on the inspection results.

In an embodiment, a method of inspecting an assembled product is provided including loading parts on a platform, moving the parts to an assembling station, assembling the parts into an assembled product at the assembling station, and moving the assembled product from the assembling station to a vision inspection station. The method includes imaging the assembled product at the vision inspection station using an imaging device, processing the images from the imaging device at a vision inspection controller based on an image analysis model to determine inspection results for the assembled product, and updating the image analysis model using an artificial intelligence learning module to configure the image analysis model based on the images received from the imaging device.

### BRIEF DESCRIPTION OF THE DRAWINGS

FIG. 1 is a schematic illustration of a product assembly machine for assembling products from a plurality of parts, such as first parts and second parts in accordance with an exemplary embodiment.

FIG. 2 is a top view of the product assembly machine in accordance with an exemplary embodiment.

FIG. 3 is a side perspective view of the product assembly machine in accordance with an exemplary embodiment.

FIG. 4 illustrates a control architecture for the product assembly machine in accordance with an exemplary embodiment.

FIG. 5 is a schematic illustration of the control architecture for the product assembly machine in accordance with an exemplary embodiment.

FIG. 6 is a flow chart showing a method of inspecting assembled products in accordance with an exemplary embodiment.

### DETAILED DESCRIPTION OF THE INVENTION

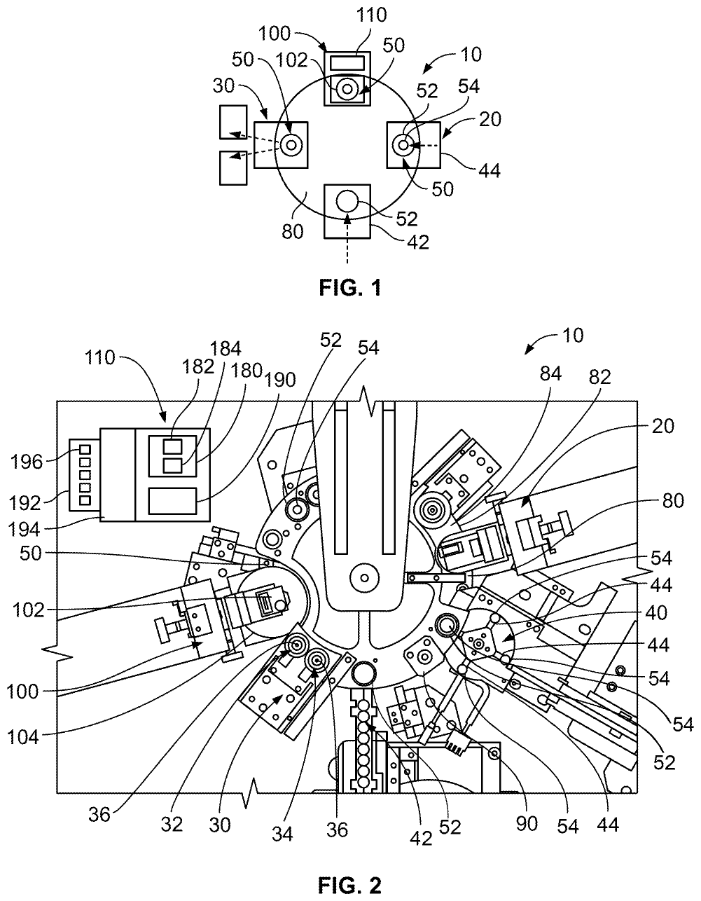

FIG. 1 is a schematic illustration of a product assembly machine 10 for assembling products 50 from a plurality of parts, such as first parts 52 and second parts 54. The parts 52, 54 are assembled together to form the assembled products 50. For example, the first parts 52 may be received in the second parts 54 during assembly. In an exemplary embodiment, the product assembly machine 10 includes one or more assembling station 20 used to assemble the various parts into the assembled products 50. In various embodiments, multiple assembling stations 20 are provided to assemble multiple parts in stages. In various embodiments, the assembled products 50 are electrical connectors. For example, the parts may include contacts, housings, circuit boards, or other types of parts to form the assembled products 50. In various embodiments, the parts may include springs, such as ring shaped springs, C-clips, and the like that are received in housings. The machine 10 may be used for manufacturing parts used in other industries in alternative embodiments.

The product assembly machine 10 includes a vision inspection station 100 used to inspect the various assembled products 50. The assembled products 50 are transported between the assembling station 20 and the vision inspection station 100. The vision inspection station 100 is used for quality inspection of the assembled products 50. The product assembly machine 10 removes defective products 50 for scrap or further inspection based on input from the vision inspection station 100. The acceptable assembled products 50 that have passed inspection by the vision inspection station 100 are transported away from the product assembly machine 10, such as to a bin or another machine for further assembly or processing.

The product assembly machine 10 includes a platform 80 that supports the parts 52, 54 and the assembled products 50 between the various stations. For example, the platform 80 is used to move the first part 52 and/or the second part 54 to the assembling station 20 where the parts 52, 54 are assembled. The platform 80 may include fixturing elements used to support and position the part 52 and/or the part 54 relative to the platform 80. The platform 80 is used to move the assembled products 50 to the vision inspection station 100. The platform 80 is used to transfer the assembled products 50 from the vision inspection station 100 to a product removal station 30 where the assembled products 50 are removed. In an exemplary embodiment, the product removal station 30 may be used to separate acceptable assembled products 50 from defective assembled products 50, such as by separating the assembled products 50 into different bins.

The vision inspection station 100 includes one or more imaging devices 102 that image the assembled products 50 on the platform 80 within a field of view of the imaging device(s) 102. The vision inspection station 100 includes a vision inspection controller 110 that receives the images from the imaging device 102 and processes the images to determine inspection results. For example, the vision inspection controller 110 determines if each assembled product 50 passes or fails inspection. The vision inspection controller 110 may reject assembled products 50 that are defective. In an exemplary embodiment, the vision inspection controller 110 includes a shape recognition tool configured to recognize the assembled products 50 in the field of view, such as boundaries of the parts 52, 54 and relative positions of the parts 52, 54. In an exemplary embodiment, the vision inspection controller 110 includes an artificial intelligence (AI) learning module used to update an image analysis model based on the images received from the imaging device 102. For example, the image analysis model may be updated based on data from the AI learning module. The image analysis model may be customized based on learning or training data from the AI learning module. The vision inspection controller 110 may be updated and trained in real time during operation of the vision inspection station 100.

After the assembled products 50 are inspected, the assembled products 50 are transferred to the product removal station 30 where the assembled products 50 are removed from the platform 80. In an exemplary embodiment, the product removal station 30 may be used to separate acceptable assembled products 50 from defective assembled products 50 based on inspection results determined by the vision inspection controller 110. The product removal station 30 may include ejectors, such as vacuum ejectors for picking up and removing the assembled products 50 from the platform 80. The product removal station 30 may include ejectors, such as pushers for removing the assembled products 50 from the platform 80. The product removal station 30 may include a multi-axis robot manipulator configured to grip and pick the products 50 off of the platform 80.

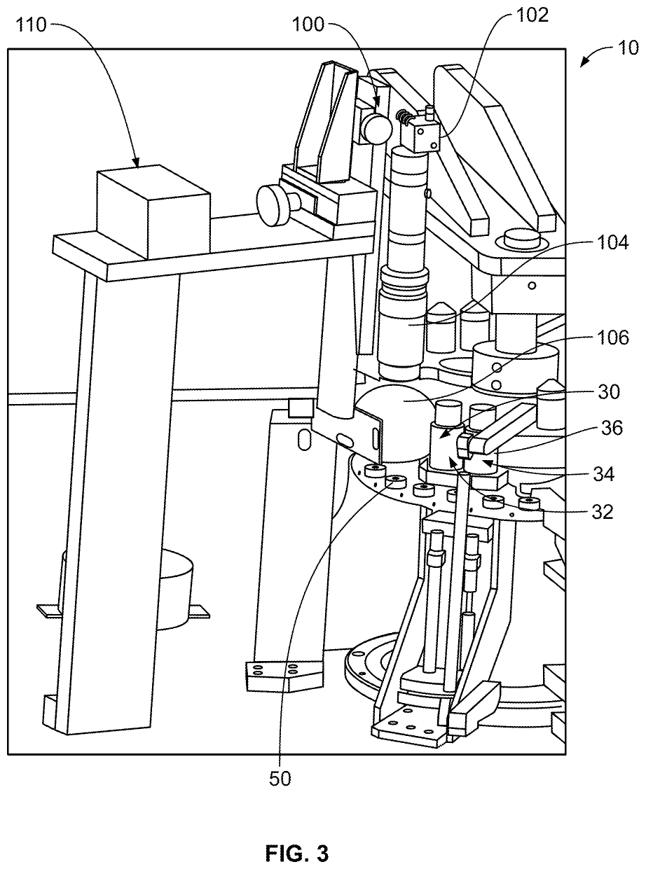

FIG. 2 is a top view of the product assembly machine 10 in accordance with an exemplary embodiment. FIG. 3 is a side perspective view of the product assembly machine 10 in accordance with an exemplary embodiment. The product assembly machine 10 includes the platform 80, a part loading station 40, the assembling station 20, the vision inspection station 100, and the product removal station 30. In an exemplary embodiment, the product assembly machine 10 may include a trigger sensor 90 for triggering one or more operations of the product assembly machine 10. The trigger sensor 90 may be used to sense presence of the assembled product 50 and/or the parts 52, 54. The trigger sensor 90 may control timing of the part loading, the imaging, the part removal, and the like.

The platform 80 includes a plate 82 having an upper surface 84 used to support the parts 52, 54 and the assembled products 50. The plate 82 may be a rotary plate in various embodiments configured to rotate the parts 52, 54 and the assembled products 50 between the various stations. In other various embodiments, the plate 82 may be another type of plate, such as a vibration tray that is vibrated to advance the assembled products 50 or a conveyor operated to advance the assembled products 50.

The part loading station 40 is used for loading the parts 52, 54 onto the platform 80, such as onto the upper surface 84 of the plate 82. In an exemplary embodiment, the part loading station 40 includes different part loading devices for the various parts 52, 54. For example, the part loading station 40 includes a first part loading device 42 for loading the first parts 52 and a second part loading device 44 for loading the second parts 54. The part loading device 42, 44 may include a hopper, a conveyor, or another type of feeding device, such as a multi-axis robot manipulator configured to grip and move the parts 52, 54 into position on the platform 80. The part loading device 42 and/or 44 may be located upstream of the assembling station 20 in the assembly process to position the parts 52, 54 relative to each other for assembly. In various embodiments, the second part loading device 44 may be located at the assembling station 20 to load the second parts 54 into the first parts 52 at the assembling station 20. The parts 52, 54 may be advanced or moved between the stations by the platform 80.

The product removal station 30 is used for removing the assembled product 50 from the platform 80. In an exemplary embodiment, the product removal station 30 includes different product removal devices. For example, the product removal station 30 includes a first product removal device 32 for removing acceptable products 50 and a second product removal device 34 for removing defective products 50. The product removal devices 32, 34 may include ejectors 36, such as vacuum ejectors for picking up and removing the assembled products 50 from the platform 80. The ejectors 36 may be mechanical pushers, such as electrically or pneumatically operated pushers, for removing the assembled products 50 from the platform 80. The product removal devices 32, 34 may include multi-axis robot manipulators configured to grip and pick the products off of the platform 80.

In an exemplary embodiment, the vision inspection station 100 includes the imaging device 102, a lens 104, and a lighting device 106 arranged adjacent an imaging area above the platform 80 to image the top of the assembled product 50. The lens 104 is used to focus the images. The lighting device 106 controls lighting of the assembled product 50 at the imaging area. The imaging device 102 may be a camera, such as a high-speed camera. Optionally, the vision inspection station 100 may include a second imaging device 102, second lens 104 and second lighting device 106, such as below the platform 80 to image the bottom of the assembled product 50. The second imaging device 102 may be at other locations to image other portions of the assembled product 50, such as a side of the assembled product 50. In other various embodiments, a second vision inspection station 100 may be provided remote from the first vision inspection station 100, such as to image the assembled product 50 at a different stage of assembly. For example, such vision inspection station 100 may be located between two different assembling stations 20.

In an exemplary embodiment, the imaging device 102 is mounted to a position manipulator for moving the imaging device 102 relative to the platform 80. The position manipulator may be an arm or a bracket that supports the imaging device 102. In various embodiments, the position manipulator may be positionable in multiple directions, such as in two-dimensional or three-dimensional space. The position manipulator may be automatically adjusted, such as by a controller that controls positioning of the position manipulators. The position manipulator may be adjusted by another control module, such as an AI control module. In other various embodiments, the position manipulator may be manually adjusted. The position of the imaging device 102 may be adjusted based on the types of assembled products 50 being imaged. For example, when a different type of assembled product 50 is being imaged, the imaging device 102 may be moved based on the type of part being imaged.

The imaging device 102 communicates with the vision inspection controller 110 through machine vision software to process the data, analyze results, record findings, and make decisions based on the information. The vision inspection controller 110 provides consistent and efficient inspection automation. The vision inspection controller 110 determines the quality of manufacture of the assembled products 50, such as determining if the assembled products 50 are acceptable or are defective. The vision inspection controller 110 identifies defects in the parts 52, 54 and/or the assembled product 50, when present. For example, the vision inspection controller 110 may determine if either of the parts 52, 54 are damaged during assembly. The vision inspection controller 110 may determine if the parts 52, 54 are correctly assembled, such as that the parts 52, 54 are in proper orientations relative to each other. The vision inspection controller 110 may determine the orientations of either or both of the parts 52, 54 and/or the assembled products 50. The vision inspection controller 110 is operably coupled to the product removal station 30 for controlling operation of the product removal station 30. The vision inspection controller 110 controls operation of the product removal station 30 based on the identified orientation of the assembled products 50.

The vision inspection controller 110 receives the images from the imaging device 102 and processes the images to determine inspection results. In an exemplary embodiment, the vision inspection controller 110 includes one or more processors 180 for processing the images. The vision inspection controller 110 determines if the assembled product 50 passes or fails inspection. The vision inspection controller 110 controls the product removal station 30 to remove the assembled products 50, such as the acceptable parts and/or the defective parts, into different collection bins (for example, a pass bin and a fail bin). In an exemplary embodiment, the vision inspection controller 110 includes a shape recognition tool 182 configured to recognize the assembled products 50 in the field of view. The shape recognition tool 182 is able to recognize and analyze the image of the assembled product 50. The shape recognition tool 182 may be used to identify edges, surfaces, boundaries and the like of the parts 52, 54 and the assembled product 50. The shape recognition tool 182 may be used to identify relative positions of the parts 52, 54 in the assembled product 50.

Once the images are received, the images are processed based on an image analysis model. The images are compared to the image analysis model to determine if the assembled product 50 has any defects. The image analysis model may be a three-dimensional model defining a baseline structure of the assembled product 50 being imaged. In other various embodiments, the image analysis model may be a series of two-dimensional models, such as for each imaging device 102. The image analysis model may be based on images of known or quality passed assembled product 50, such as during a learning or training process. The image analysis model may be based on the design specifications of the assembled product 50. For example, the image analysis model may include design parameters for edges, surfaces, and features of the assembled product 50. The image analysis model may include tolerance factors for the parameters, allowing offsets within the tolerance factors. During processing, the images may be individually processed or may be combined into a digital model of the assembled product 50, which is then compared to the image analysis model. The images may be processed to detect damage, improper orientation, partial assembly, full assembly, over-assembly, dirt, debris, dents, scratches, or other types of defects. The images may be processed by performing pattern recognition of the images based on the image analysis model. For example, in an exemplary embodiment, the vision inspection controller 110 includes a pattern recognition tool 184 configured to compare patterns or features in the images to patterns or features in the image analysis model. The images may be processed by performing feature extraction of boundaries and surfaces detected in the images and comparing the boundaries and surfaces to the image analysis model. The vision inspection controller 110 may identify lines, edges, bridges, grooves, or other boundaries or surfaces within the image.

In an exemplary embodiment, the vision inspection controller 110 may perform pre-processing of the image data. For example, the vision inspection controller 110 may perform contrast enhancement and/or noise reduction of the images during processing. The vision inspection controller 110 may perform image segmentation during processing. For example, the vision inspection controller may crop the image to an area of interest or mask areas of the image outside of the area of interest, thus reducing the data that is processed by the vision inspection controller 110. The vision inspection controller 110 may identify areas of interest within the image for enhanced processing.

In an exemplary embodiment, the vision inspection controller 110 includes an artificial intelligence (AI) learning module 190. The AI learning module 190 uses artificial intelligence to train the vision inspection controller 110 and improve inspection accuracy of the vision inspection controller 110. The AI learning module 190 update image analysis based on the images received from the imaging device 102. The vision inspection controller 110 is updated and trained in real time during operation of the vision inspection station 100. The AI learning module 190 of the vision inspection controller 110 may be operable in a learning mode to train the vision inspection controller 110 and develop the image analysis model. The image analysis model changes over time based on input from the AI learning module 190 (for example, based on images of the assembled products 50 taken by the imaging device 102). The image analysis model may be updated based on data from the AI learning module. For example, an image library used by the image analysis model may be updated and used for future image analysis. The imaging analysis module may use a shape recognition tool or a pattern recognition tool for analyzing shapes, boundaries or other features of the assembled products 50 in the image and such shape or pattern recognition tools may be used by the AI learning module 190 to update and train the AI learning module, such as by updating an image library used by the AI learning module 190. In various alternative embodiments, the AI learning module 190 may be a separate module from the vision inspection controller 108 and independently operable from the vision inspection controller 110. For example, the AI learning module 190 may be separately coupled to the imaging devices 102 or other components of the machine.

In an exemplary embodiment, the vision inspection controller 110 includes a user interface 192. The user interface 192 includes a display 194, such as a monitor. The user interface 192 includes one or more inputs 196, such as a keyboard, a mouse, buttons, and the like. An operator is able to interact with the vision inspection controller 110 with the user interface 192.

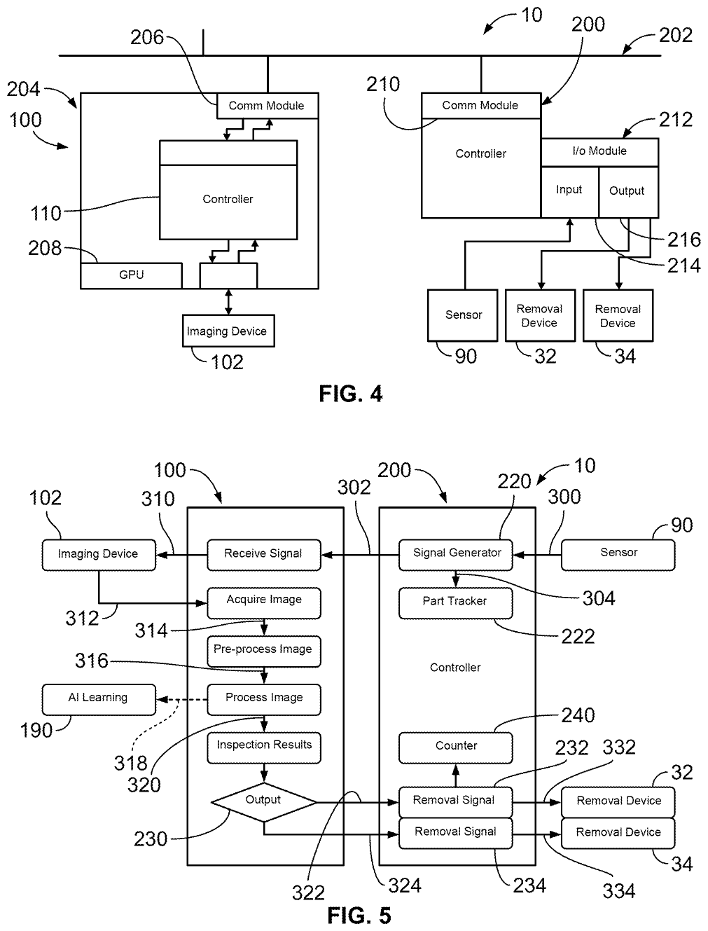

FIG. 4 illustrates a control architecture for the product assembly machine 10. In an exemplary embodiment, the product assembly machine 10 includes a machine controller 200 for controlling operation of various components of the machine 10. The machine controller 200 communicates with the vision inspection system 100 through a network 202, such as a TCP/IP network.

The vision inspection system 100 may be embodied in a computer 204. The vision inspection controller 110 may be provided on the computer 204. The vision inspection system 100 includes a communication module 206 coupled to the network 202. The vision inspection controller 110 is communicatively coupled to the communication module 206, such as to communicate with the machine controller 200 or other component. The imaging device 102 is coupled to the vision inspection system 100. The vision inspection system 100 includes a graphics processing unit (GPU) 208 for processing the images from the imaging device 102.

The machine controller 200 includes a communication module 210 coupled to the network 202. The machine controller 200 communicates with the vision inspection controller 110 through the network 202. The machine controller 200 includes an I/O module 212 having an input 214 and an output 216. The trigger sensor 90 is coupled to the I/O module 212. Trigger signals from the trigger sensor 90, such as the presence of one of the parts 52, 54 and/or the assembled product 50 (for example, when the part 52, 54 or the assembled product passes the trigger sensor 90), are transmitted to the input 214. The machine controller 200 communicates such trigger signal to the vision inspection controller 110. The product removal devices 32, 34 are communicatively coupled to the output 216. Control signals for controlling the product removal devices 32, 34 are transmitted to the product removal devices 32, 34 through the output 216. The control signals for the product removal devices 32, 34 are based on the inspection results determined by the vision inspection controller 110.

FIG. 5 is a schematic illustration of the control architecture for the product assembly machine 10. During operation of the product assembly machine 10, at 300, the trigger sensor 90 sends a trigger signal to the machine controller 200 upon a triggering event, such as when the part 52, 54 or the assembled product 50 passes the trigger sensor 90. In an exemplary embodiment, the platform 80 rotates the assembled product 50 past the trigger sensor 90 between the stations, such as to the imaging device 102. At 302, the machine controller 200 generates a trigger signal at a trigger signal generator 220. In an exemplary embodiment, the machine controller 200 includes a part tracker 222. At 304, the part tracker 222 tracks the part 52, 54 or the assembled product 50 as the part 52, 54 or the assembled product 50 is moved (for example, rotated) between the stations. The part tracker 222 may use the trigger signals from the trigger signal generator 220 to track the parts 52, 54 or the assembled product 50.

At 310, the vision inspection system 100 receives the trigger signal from the trigger signal generator 220 of the machine controller 200. The vision inspection system 100 controls operation of the imaging device 102 based on the trigger signals received. For example, the timing of the imaging is controlled based on the trigger signals. At 312, the images are acquired by the vision inspection controller 110. At 314, the vision inspection controller 110 pre-processes the images, such as for noise reduction. For example, areas of interest may be identified and the images may be cropped or masked outside of such areas of interest. The vision inspection controller 110 may perform contrast enhancement and/or image segmentation.

At 316, the vision inspection controller 110 processes the images to determine if the assembled product 50 passes or fails inspection. In an exemplary embodiment, the vision inspection controller 110 recognizes shapes or features of the assembled products 50 in the field of view to analyze the image of the assembled product 50. For example, the shape recognition tool 182 may be used to identify edges, surfaces, boundaries and the like of the parts 52, 54 and the assembled product 50 to identify relative positions of the parts 52, 54 in the assembled product 50. In an exemplary embodiment, the images are processed based on an image analysis model. The images are compared to the image analysis model to determine if the assembled product 50 has any defects. The image analysis model may be a three-dimensional model defining a baseline structure of the assembled product 50 being imaged. In other various embodiments, the image analysis model may be a series of two-dimensional models, such as for each imaging device 102. The image analysis model may be based on images of known or quality passed assembled product 50, such as during a learning or training process. The image analysis model may be based on the design specifications of the assembled product 50. For example, the image analysis model may include design parameters for edges, surfaces, and features of the assembled product 50. The image analysis model may include tolerance factors for the parameters, allowing offsets within the tolerance factors. During processing, the images may be individually processed or may be combined into a digital model of the assembled product 50, which is then compared to the image analysis model. The images may be processed by performing pattern recognition of the images based on the image analysis model to compare patterns or features in the images to patterns or features in the image analysis model. The images may be processed by performing feature extraction of boundaries and surfaces detected in the images and comparing the boundaries and surfaces to the image analysis model. The vision inspection controller 110 may identify lines, edges, bridges, grooves, or other boundaries or surfaces within the image. The images may be processed to detect damage, improper orientation, partial assembly, full assembly, over-assembly, dirt, debris, dents, scratches, or other types of defects.

At 318, the vision inspection system 100 may optionally transmit the processed image to the AI learning module 190. The images may be used by the AI learning module 190 to update the image analysis model. The AI learning module 190 may use a shape recognition tool or a pattern recognition tool for analyzing shapes, boundaries or other features of the assembled products 50 in the image and such shape or pattern recognition tools may be used by the AI learning module 190 to update and train the AI learning module, such as by updating an image library used by the AI learning module 190.

At 320, the vision inspection controller 110 determines inspection results and generates an inspection result output. The inspection results are based on the image analysis model. In various embodiments, the inspection result output may be pass/fail inspection results. For example, the inspection result output may be a pass output if the vision inspection controller 110 determines that the assembled product 50 is acceptable or the inspection result output may be a fail output if the vision inspection controller 110 determines that the assembled product 50 is defective. Other inspection result outputs may be provided in alternative embodiments, such as a result that further inspection is needed, such as by the operator.

The vision inspection controller 110 includes a results output signal generator 230 to transmit inspection results to the machine controller 200. At 322, the vision inspection controller 110 sends a pass signal to the machine controller 200 when the inspection result output is a pass output. At 324, the vision inspection controller 110 sends a fail signal to the machine controller 200 when the inspection result output is a fail output.

The machine controller 200 includes a first product removal device signal generator 232 generating activation signals for the first product removal device 32. At 332, the first product removal device signal generator 232 generates an activation signal for activating the first product removal device 32 when the pass signal is received from the vision inspection controller 110. The first product removal device 32 is operated to remove the acceptable assembled product from the platform 80, such as into a pass bin. The machine controller 200 includes a second product removal device signal generator 234 generating activation signals for the second product removal device 34. At 334, the second product removal device signal generator 234 generates an activation signal for activating the second product removal device 34 when the fail signal is received from the vision inspection controller 110. The second product removal device 34 is operated to remove the defective assembled product from the platform 80, such as into a fail bin. Optionally, the first product removal device signal generator 232 and/or the second product removal device signal generator 234 may send signals to a product counter 240 for counting the number of assembled products 50 that are acceptable (pass) and/or for counting the number of assembled products 50 that are defective (fail).

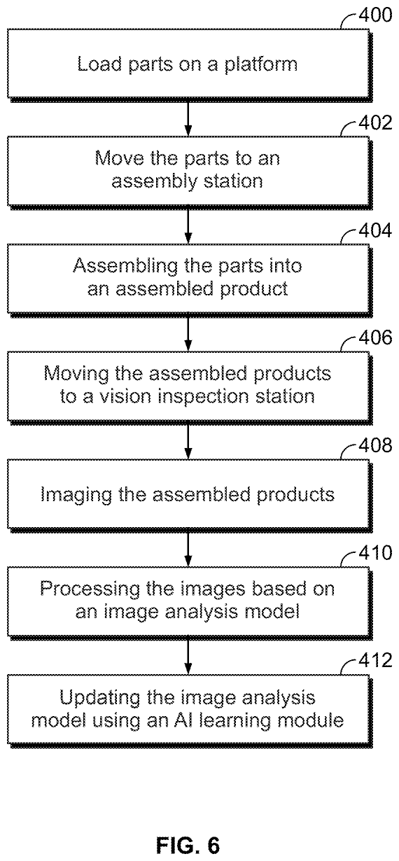

FIG. 6 is a flow chart showing a method of inspecting assembled products in accordance with an exemplary embodiment. The method, at 400, includes loading parts 52, 54 on the platform 80. The parts 52, 54 may be loaded manually or automatically. The first parts 52 may be loaded into a first position and the second parts 54 may be loaded into a second position. In various embodiments, the second parts 54 may be loaded into the first parts 52.

At 402, the method includes moving the parts 52, 54 to an assembling station 20. The platform 80 is used to move the first parts 52 and/or the second parts 54. The platform 80 may be rotated to move the first parts 52 and/or the second parts 54. For example, the platform 80 may be circular and rotated to move the first parts 52 and/or the second parts 54. In other various embodiments, the parts 52, 54 may be moved by a conveyor, a pusher, or another moving device.

At 404, the method includes assembling the parts 52, 54 into an assembled product 50 at the assembling station 20. The first parts 52 may be loaded into the second parts 54 at the assembling station 20. For example, the first parts 52 may be springs and the second parts 54 may be a housing with the springs being loaded into the housing. Other types of parts may be assembled in the assembling station 20 in alternative embodiments. After the parts 52, 54 are assembled, the assembled products 50, at 406, are moved from the assembling station 20 to the vision inspection station 100. The platform 80 is used to move the assembled products 50 to the vision inspection station 100. For example, the assembled products 50 may be rotated from the assembling station 20 to the vision inspection station 100.

At 408, the method includes imaging the assembled products 50 at the vision inspection station 100 using the imaging device 102. In an exemplary embodiment, the imaging device 102 is located directly above the platform 80 to view the assembled products 50 from above. The timing of the imaging may be controlled using the trigger sensor 90 to detect when the assembled product 50 moves to the vision inspection station 100.

At 410, the method includes processing the images from the imaging device 102 at the vision inspection controller 110 based on an image analysis model to determine inspection results for the assembled product 50. The vision inspection controller 110 receives the images from the imaging device 102. The vision inspection controller 110 includes the shape recognition tool 182 used to analyze the images of the assembled products 50. In various embodiments, the images are processed by comparing the image to the image analysis model to determine if the assembled product 50 has any defects. In various embodiments, the images are processed by performing pattern recognition of the images based on the image analysis model. In various embodiments, the images are processed by performing feature extraction of boundaries and surfaces detected in the images and comparing the boundaries and surfaces to the image analysis model.

At 412, the method includes updating the image analysis model using the AI learning module 190 to configure the image analysis model based on the images received from the imaging device 102. The image analysis model is updated based on the images from the imaging device 102. The images forming the basis of the image analysis model may be revised or updated based on images taken by the imaging devices 102, using the AI learning module 190. For example, the image analysis model may be based on multiple images, which are updated or expanded based on images from the AI learning module 190. As the AI learning module 190 expands the image analysis model, the quality of the image processing may be improved.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

1. A product assembly machine comprising:
a platform supporting parts configured to be assembled to form an assembled product, the platform being movable between a first position and a second position, the platform moving the assembled product from an assembling station at the first position to a vision inspection station at the second position;
the assembling station having a part assembly member for assembling the parts into the assembled product; and
the vision inspection station including an imaging device to image the assembled product, the vision inspection station having a vision inspection controller receiving images from the imaging device and processing the images from the imaging device based on an image analysis model to determine inspection results for the assembled product, the vision inspection controller having an artificial intelligence learning module operated to update the image analysis model based on the images received from the imaging device.

2. The product assembly machine of claim 1, wherein the product assembly machine loads a first part of the parts into a second part of the parts, the vision inspection controller determining relative positions of the first and second parts in the assembled product to determine inspection results for the assembled product.

3. The product assembly machine of claim 1, wherein the vision inspection controller performs image cropping prior to processing the images.

4. The product assembly machine of claim 1, wherein the vision inspection station is a first vision inspection station, the product assembly machine further comprising a second vision inspection station remote from the first vision inspection station, the second vision inspection station including a second imaging device to image the assembled product, wherein at least one of the vision inspection controller and a second vision inspection controller of the second vision inspection station receives images from the second imaging device and processes the images from the second imaging device.

5. The product assembly machine of claim 4, wherein the second vision inspection station inspects the assembled product at a different stage of assembly as the first vision inspection station.

6. The product assembly machine of claim 4, wherein the second vision inspection station inspects the assembled product from a different angle as the first vision inspection station.

7. The product assembly machine of claim 6, wherein the first vision inspection station and the second vision inspection station image the assembled product simultaneously.

8. The product assembly machine of claim 1, wherein the imaging device includes a camera, a lens, and a lighting device, operation of the camera, the lens, and the lighting device being controlled based on the type of assembled product being imaged.

9. The product assembly machine of claim 1, further comprising a machine controller operably coupled to the vision inspection controller, the machine controller receiving the inspection results from the vision inspection controller, the machine controller including a product removal control device operably coupled to a product removal device used to remove the assembled product from the platform, the product removal control device controlling the product removal device based on the inspection results.

10. The product assembly machine of claim 9, wherein the product removal control device includes a vacuum element used to remove the assembled product from the platform.

11. The product assembly machine of claim 9, wherein the product removal control device includes a robot arm and a gripper at a distal end of the robot arm, the gripper being configured to pick the assembled product off of the platform based on the inspection results.

12. The product assembly machine of claim 9, wherein the inspection results include a pass result if the processed image is acceptable based on the image analysis model and the inspection results include a fail result if the processed image is defective based on the image analysis model, the product removal control device removing the assembled product to a pass bin when determined to be acceptable and the product removal control device removing the assembled product to a fail bin when determined to be rejected.

13. The product assembly machine of claim 1, further comprising a machine controller operably coupled to the vision inspection controller, the product assembly machine further comprising a trigger sensor detecting presence of the parts or the assembled product on the platform, the machine controller being operably coupled to the trigger sensor, the machine controller controlling operation of the imaging device based on input from the trigger sensor.

14. The product assembly machine of claim 1, wherein the platform is configured to rotate to move the parts and the assembled product relative to the vision inspection station.

15. The product assembly machine of claim 1, further comprising a first product removal device and a second product removal device, the platform moving the assembled product from the vision inspection station to at least one of the first product removal device and the second product removal device to remove the assembled product from the platform based on the inspection results.

16. The product assembly machine of claim 1, wherein the vision inspection controller includes a pattern recognition tool analyzing the images to recognize features of the parts relative to each other in the assembled product.

17. The product assembly machine of claim 1, wherein the image analysis model changes over time based on input from the artificial intelligence learning module.

18. The product assembly machine of claim 1, wherein the vision inspection controller processes the images by performing pattern recognition based on the image analysis model.

19. The product assembly machine of claim 1, wherein the vision inspection controller processes the images by performing feature extraction of boundaries and surfaces in the images and comparing the boundaries and surfaces to the image analysis model.

20. A product assembly machine comprising:
a rotary platform having an upper surface, the platform being movable between a first position and a second position;
a first part feeding device feeding a first part to the rotary platform;
a second part feeding device feeding a second part to the rotary platform;
an assembling station at the first position having a part assembly member for assembling the first part with the second part into an assembled product, wherein the rotary platform is used to move at least one of the first part and the second part to the assembling station; and
a vision inspection station adjacent the rotary platform at the second position, the rotary platform moving the assembled product from the assembling station to the vision inspection station, the vision inspection station including an imaging device to image the assembled product, the vision inspection station having a vision inspection controller receiving images from the imaging device and processing the images from the imaging device based on an image analysis model to determine inspection results for the assembled product, the vision inspection controller having an artificial intelligence learning module operated to update the image analysis model based on the images received from the imaging device, wherein the rotary platform is used to move the inspected assembled product to a product removal device to remove the inspected assembled product based on the inspection results.

21. A method of inspecting an assembled product comprising:
loading parts on a platform;
moving the parts to an assembling station;
assembling the parts into an assembled product at the assembling station;
moving the assembled product from the assembling station to a vision inspection station;
imaging the assembled product at the vision inspection station using an imaging device;
processing the images from the imaging device at a vision inspection controller based on an image analysis model to determine inspection results for the assembled product; and updating the image analysis model using an artificial intelligence learning module to configure the image analysis model based on the images received from the imaging device.
